(19) United States
(12) Patent Application Publication
(10) Pub. No.: US 2007/0221268 A1
(43) Pub. Date: Sep. 27, 2007

(54) Encapsulants for electronic components

(76) Inventor: Bruce Michael Hasch, Nederland, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/386,143

(22) Filed: Mar. 21, 2006

(51) Int. Cl. H02N 6/00

(52) U.S. Cl. 136/251

(57) ABSTRACT

An electronic device comprising an electronic component encapsulated by a composition comprising crosslinked ethylene copolymer blended with from about 150 to about 1,000 parts by weight per million parts by weight (ppm) of the ethylene copolymer of fatty acid amide, and manufacture of the electronic device. One preferred electronic device is a photovoltaic solar cell module wherein the electronic component comprises photovoltaic cells and the composition is a transparent composition. In addition, a composition comprising ethylene copolymer blended with from about 150 to less than 500 parts by weight per million parts by weight (ppm) of the ethylene copolymer of fatty acid amide. Further, a transparent laminate comprising at least one layer of transparent glass and at least one layer of a transparent composition comprising an ethylene copolymer blended with from about 150 to 1,000 parts by weight per million parts by weight of the ethylene copolymer of a fatty acid amide.

### FIELD OF THE INVENTION

This invention pertains to photovoltaic modules, and use of ethylene copolymer encapsulants for encapsulating photovoltaic solar cells therein.

### BACKGROUND OF THE INVENTION

Electronic components are frequently encapsulated for protection. For instance, photovoltaic modules (also known as solar panels or modules) typically comprise photovoltaic solar cells (i.e., semiconductors) encapsulated into water-tight modules for protection from moisture and impact. The principle components of many modules are a glass glazing, crosslinked ethylene copolymer encapsulant, the silicon wafers and associated wiring, and a protective backsheet. Flexible modules containing thin film surface layers are also available and comprise a thin transparent polymeric film, such as fluoropolymer film, for example Tedlar® and Tefzel® films (DuPont), or a biaxially-oriented polyester (e.g., poly(ethylene terephthalate)) film, crosslinked ethylene copolymer encapsulant, silicon wafers and associated wiring, and a flexible protective backsheet. Ethylene-vinyl acetate (EVA), available as ELVAX® from E. I. du Pont de Nemours and Company, Wilmington, Del. (DuPont), is one example of an ethylene copolymer which is used to encapsulate the photovoltaic solar cells, and is commonly selected because it has excellent optical qualities, is easy to process, and has excellent physical properties including thermal and mechanical stability. See, e.g., U.S. Pat. No. 4,499,658, U.S. Pat. No. 5,380,371, U.S. Pat. No. 6,093,757 and EP 1 164 167. Practioners would like to have an EVA for encapsulating that has the following properties: high transparency, good resistance to weathering, high thermal stability, and high mechanical strength with a relatively low modulus.

### SUMMARY OF THE INVENTION

This invention is directed to an electronic device comprising an electronic component encapsulated by a composition comprising crosslinked ethylene copolymer blended with from about 150 to about 1,000 parts by weight per million parts by weight (ppm) of the ethylene copolymer of fatty acid amide.

Preferably the electronic device is a photovoltaic solar cell module wherein the electronic component comprises photovoltaic cells (e.g., photovoltaic silicon wafers).

Preferably the composition is a transparent composition. Preferably the composition contains less than 500 ppm, more preferably 490 ppm or less, and most preferably 450 ppm or less, of the fatty acid amide.

Preferably the composition contains at least about 200 ppm of the fatty acid amide.

The fatty acid amide is preferably selected from the group consisting of olefinic bisoleamides, erucamide, stearamide, behenamide, oleamide, and mixtures thereof, more preferably from the group consisting of olefinic bisoleamides and mixtures thereof. Even more preferably the fatty acid amide is selected from the group consisting of N,N′-ethylenebisoleamide, N,N′-ethylenebiserucamide, N,N′-dioleyladipamide, N,N′-dierucyladipamide, and mixtures thereof.

Preferably the photovoltaic solar cell module comprises a glass glazing, the silicon wafers and associated wiring encapsulated by the composition, and a protective backsheet.

Another preferred embodiment is directed to a flexible photovoltaic solar cell module, comprising thin transparent flexible polymeric film, the photovoltaic cells (e.g., silicon wafers) and associated wiring encapsulated by the composition, and a flexible protective backsheet.

Preferably the composition has a haze value of up to about 20.

Preferably the composition has a stick temperature of at least about 25° C.

Preferably the composition has a haze value of less than 10% more than the same composition prepared without the fatty acid amide.

In one preferred embodiment, the ethylene copolymer is an ethylene vinyl acetate copolymer. In another preferred embodiment, the ethylene copolymer is selected from the group consisting of ethylene-alkyl (meth)acrylate copolymers.

Preferably the electronic device is a photovoltaic solar cell module wherein the electronic component comprises photovoltaic cells prepared from a laminate comprising a transparent cover layer, a backsheet on the side opposite the transparent layer, first and second sheets disposed between the transparent cover layer and the backsheet and each comprising the composition, and an array of electrically interconnected photovoltaic cells disposed between the first and second support sheets.

The invention is also directed to a composition comprising ethylene copolymer blended with from about 150 to less than 500 parts by weight per million parts by weight (ppm) of the ethylene copolymer of fatty acid amide. Preferably the composition is a transparent composition. Preferably the composition contains 490 ppm or less, and most preferably 450 ppm or less, of the fatty acid amide. Preferably the composition contains at least about 200 ppm of the fatty acid amide.

The invention is further directed to a transparent laminate comprising at least one layer of transparent rigid or flexible sheet, preferably glass or hardcoat, and most preferably glass, and at least one layer of a transparent composition comprising an ethylene copolymer blended with from about 150 to about 1,000 parts by weight per million parts by weight (ppm) of the ethylene copolymer of fatty acid amide. Preferably the composition is a transparent composition. Preferably the composition contains less than 500 ppm, more preferably 490 ppm or less, and most preferably 450 ppm or less, of the fatty acid amide.

Preferably the composition contains at least about 200 ppm of the fatty acid amide.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing and/or claiming this invention, the term “copolymer” is used to refer to polymers containing two or more monomers. The use of the term “terpolymer” and/or “termonomer” means that the copolymer has at least three different comonomers.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof produced therefrom.

The materials, methods, and examples herein are illustrative only and, except as specifically stated, are not intended to be limiting.

The compositions comprise an ethylene copolymer blended with from about 150 to by weight per million parts by weight of the ethylene copolymer (ppm) of fatty acid amide. Preferably they contain at least about 175 ppm, more preferably at least about 200 ppm, of the fatty acid amide. Preferably they contain less than 500 parts, more preferably 490 ppm or less, and most preferably about 450 ppm or less, of the fatty acid amide. These compositions are of the general type described in the literature and can be prepared by the general techniques described in the literature, such as U.S. Pat. No. 4,510,281, U.S. Pat. No. 6,528,174 B1, and US 2005/0065250 A1.

Ethylene copolymers useful in this invention are well known. A few preferred copolymers are described below.

One preferred class of ethylene copolymers is ethylene vinyl acetate copolymers.

One preferred class of ethylene vinyl acetate copolymers predominantly comprises repeat units from ethylene and vinyl acetate. Preferably the amount of ethylene is at least about 45 weight percent, by weight of the copolymer. Preferably the amount of ethylene is up to about 82 weight percent, by weight of the copolymer. Preferably the amount of vinyl acetate is at least about 18 weight percent, by weight of the copolymer. Preferably the amount of vinyl acetate is up to about 55 weight percent, by weight of the copolymer.

Another preferred class of ethylene vinyl acetate copolymers is terpolymers predominantly made from ethylene, vinyl acetate and carbon monoxide. Preferably the amount of ethylene is at least about 48 weight percent, by weight of the copolymer. Preferably the amount of ethylene is up to about 77 weight percent, by weight of the copolymer. Preferably the amount of vinyl acetate is at least about 20 weight percent, by weight of the copolymer. Preferably the amount of vinyl acetate is up to about 40 weight percent, by weight of the copolymer. Preferably the amount of carbon monoxide is at least about 3 weight percent, by weight of the copolymer. Preferably the amount of carbon monoxide is up to about 12 weight percent, by weight of the copolymer.

Another preferred class of ethylene copolymers includes ethylene-alkyl(meth)acrylate copolymers, preferable copolymers of ethylene with methyl acrylate, ethyl acrylate, or n-butyl acrylate. Preferably the amount of ethylene is at least 50 weight precent, by weight of the copolymer. Preferably the amount of ethylene is up to about 75 weight precent, by weight of the copolymer. The amount of (meth)acrylate is preferably at least 25 weight % and preferably up to about 50 weight percent, by weight of the copolymer.

Ethylene copolymers useful in this invention include those sold by DuPont under the trademark ELVAX, including those sold under the grade designations 210, 220, 250/3180, 260/3175, 3185, 3185/150/PV1400, PV1410, 240, PV1410, and those sold under the trademark ELVALOY, including those sold under the grade designations 1330 AC, 3135 AC and 3427 AC.

The compositions of this invention comprise a fatty acid amide. Preferred fatty acid amides are selected from olefinic bisoleamides, erucamide, stearamide, behenamide, oleamide, and mixtures thereof.

One preferred group of fatty acid amides is olefinic bisoleamides. The olefinic bisoleamides are generally selected from a compound of the formula:
R—C(O)—NHCH₂CH₂NHC(O)—R
wherein R is selected from C₄-C₂₅ saturated or unsaturated hydrocarbon moieties. The most preferred olefinic bisoleamides are selected from the group consisting of N,N′-ethylenebisoleamide, N,N′-ethylenebiserucamide, N,N′-dioleyladipamide, and N,N′-dierucyladipamide. N,N′-Ethylenebisoleamide, the most preferred additive, is available commercially from Rohm and Haas (Philadelphia, Pa.), under the name “Advawax” 240; from Chemtura (Middelbury, Conn.), under the name “Kemamide” W-20; and from Lonza (Switzerland) under the name “Glycolube” VL.

It is understood that the compositions of the present invention can be used with additives known within the art. They can include, for example, plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. For example, typical colorants may include a bluing agent to reduce yellowing, a colorant may be added to color the laminate or control solar light.

The compositions of the present invention may incorporate an effective amount of a thermal stabilizer. Thermal stabilizers are well disclosed within the art. Any known thermal stabilizer will find utility within the present invention. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. This should not be considered limiting. Essentially any thermal stabilizer known within the art will find utility within the present invention. The compositions of the present invention preferably incorporate from about 0 to about 10 weight percent thermal stabilizers, based on the total weight of the composition. More preferably, the compositions of the present invention incorporate from about 0 to about 5 weight percent thermal stabilizers, based on the total weight of the composition. Most preferably, the compositions of the present invention incorporate from about 0 to about 1 weight percent thermal stabilizers, based on the total weight of the composition.

The compositions of the present invention may incorporate an effective amount of UV absorbers. UV absorbers are well disclosed within the art. Any known UV absorber will find utility within the present invention. Preferable general classes of UV absorbers include benzotriazoles, hydroxybenzophenones, hydroxyphenyl triazines, esters of substituted and unsubstituted benzoic acids, and the like and mixtures thereof. This should not be considered limiting. Essentially any UV absorber known within the art will find utility within the present invention. The compositions of the present invention preferably incorporate from about 0 to about 10 weight percent UV absorbers, based on the total weight of the composition. More preferably, the compositions of the present invention incorporate from about 0 to about 5 weight percent UV absorbers, based on the total weight of the composition. Most preferably, the compositions of the present invention incorporate from about 0 to about 1 weight percent UV absorbers, based on the total weight of the composition.

The compositions of the present invention may incorporate an effective amount of hindered amine light stabilizers, (HALS). Hindered amine light stabilizers, (HALS), are generally well disclosed within the art. Generally, hindered amine light stabilizers are disclosed to be secondary, tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function. This should not be considered limiting, essentially any hindered amine light stabilizer known within the art may find utility within the present invention. The compositions of the present invention preferably incorporate from about 0 to about 10 weight percent hindered amine light stabilizers, based on the total weight of the composition. More preferably, the compositions of the present invention incorporate from about 0 to about 5 weight percent hindered amine light stabilizers, based on the total weight of the composition. Most preferably, the compositions of the present invention incorporate from about 0 to about 1 weight percent hindered amine light stabilizers, based on the total weight of the composition.

Any known plasticizer may be used with the compositions. Examples of plasticizers include, for example, polybasic acid esters and polyhydric alcohol esters, such as dioctyl phthalate, dihexyladipate, triethylene glycol-di-2-ethylbutylate, butyl sebacate, tetraethylene glycol heptanoate, triethylene glycol dipelargonate and the like and mixtures thereof. Generally, the plasticizer level within the poly(ethylene-co-vinyl acetate) resin composition does not exceed about 5 weight percent based on the weight of the total composition.

The compositions preferably incorporates an organic peroxide. Preferably, the organic peroxide has a thermal decomposition temperature of about 70° C. or greater in a half-life of 10 hours.

Preferably, the organic peroxide has a thermal decomposition temperature of about 100° C. or greater. The selection of the appropriate organic peroxide may be performed by one skilled in the art with consideration of sheet-forming temperature, process for preparing the composition, curing (bonding) temperature, heat resistance of body to be bonded, storage stability, and the like. Specific examples of the preferred organic peroxide include, for example, 2,5-dimethylhexane-2,5-dihydroperoxide, 2,5-dimethyl-2,5-(t-butylperoxy)hexane-3-di-t-butylperoxide, t-butylcumyl peroxide, 2,5-dimethyl-2,5-di(t-butylperoxy)hexane, dicumyl peroxide, alpha, alpha′-bis(t-butylperoxyisopropyl)benzene, n-butyl-4,4-bis(t-butylperoxy)valerate, 2,2-bis(t-butylperoxy)butane, 1,1-bis(t-butylperoxy)cyclohexane, 1,1-bis(t-butylperoxy)-3,3,5-trimethylcyclohexane, t-butylperoxybenzoate, benzoyl peroxide, t-butylperoxyacetate, methyl ethyl ketone peroxide, 2,5-dimethyl-2,5-bis(t-butylperoxy)-3,3,5-trimethylcyclohexane, 1-bis(t-butylperoxy)cyclohexane, 2,5-dimethylhexyl-2,5-bisperoxybenzoate, t-butyl hydroperoxide, p-menthane hydroperoxide, p-chlorobenzoyl peroxide, hydroxyheptyl peroxide, chlorohexanone peroxide, octanoyl peroxide, decanoyl peroxide, lauroyl peroxide, cumyl peroxyoctoate, succinic acid peroxide, acetyl peroxide, t-butylperoxy(2-ethylhexanoate), m-toluoyl peroxide, t-butylperoxyisobutylate and 2,4-dichlorobenzoyl peroxide and the like and mixtures thereof. Preferably, the organic peroxide level is within the range of from about 0.1 weight percent to about 5 weight percent, based on the total weight of the poly(ethylene-co-vinyl acetate) resin composition.

Alternatively, the compositions may be cured by light. In this instance, the organic peroxide may be replaced with a photoinitiator or photosensitizer. Preferably, the level of the photoinitiator is within the range of from about 0.1 weight percent to about 5 weight percent, based on the total weight of the poly(ethylene-co-vinyl acetate) resin composition. Specific examples of the preferred photoinitiator include, for example, benzoin, benzophenone, benzoyl methyl ether, benzoin ethyl ether, benzoin isopropyl ether, benzoin isobutyl ether, dibenzyl, 5-nitroacenaphtene, hexachlorocyclopentadiene, p-nitrodiphenyl, p-nitroaniline, 2,4,6-trinitroaniline, 1,2-benzanthraquinone, 3-methyl-1,3-diaza-1,9-benzanthrone and the like and mixtures thereof.

The compositions may also incorporate a silane coupling agent to enhance the adhesive strengths. Specific examples of the preferable silane coupling agent may include, for example, gamma-chloropropylmethoxysilane, vinyltriethoxysilane, vinyltris(beta-methoxyethoxy)silane, gamma-methacryloxypropylmethoxysilane, vinyltriacetoxysilane, gamma-glycidoxypropyltrimethoxysilane, gamma-glycidoxypropyltriethoxysilane, beta-(3,4-epoxycyclohexyl)ethyltrimethoxysilane, vinyltrichlorosilane, gamma-mercaptopropylmethoxysilane, gamma-aminopropyltriethoxysilane, N-beta-(aminoethyl)-gamma-aminopropyltrimethoxysilane, and the like and mixtures thereof. These silane coupling agent materials are preferably used at a level of about 5 weight percent or less, based on the total weight of the composition. These silane coupling agent materials are more preferably used at a level within the range of from about 0.001 weight percent to about 5 weight percent, more preferably from about 0.1 weight percent to about 1 weight percent, based on the total weight of the poly(ethylene-co-vinyl acetate) resin composition.

The compositions of this invention can be prepared by any convenient technique. For instance, they can be prepared by the general techniques described in the literature, such as U.S. Pat. No. 4,510,281, U.S. Pat. No. 6,528,174 B1, and US 2005/0065250 A1. According to U.S. Pat. No. 6,528,174 B1, the fatty acid amides can be added to the ethylene copolymers in the melt, as a dry powder below its melting temperature, or as a concentrate in the same or any compatible polymer. The fatty acid amides are thoroughly blended with the ethylene copolymers. In another preferred embodiment, ethylene copolymer and a masterbatch comprising about 5 to 15 weight % (preferably about 10 weight %), by weight of the composition, of fatty acid amine in ethylene copolymer are prepared separately and added together as a melt.

The composition preferably has a haze value of less than 10% more than the same composition prepared without the fatty acid amide.

The compositions of this invention preferably have a haze value of about 20 or less using the measurement technique described below. Haze values should be as low as possible and can be as low as 0 with a thin film. With thicker films haze values will typically be about 5 to 20, preferably about 15 or less.

The composition preferably has a stick temperature of at least about 25° C. Stick temperatures of about 50° C. or more can be achieved using some of the compositions of the invention.

Electronic components are frequently encapsulated for protection, and the compositions of this invention can be used to encapsulate them using many techniques.

Photovoltaic modules (also known as solar panels or modules) of this invention comprise photovoltaic solar cells (i.e., semiconductors) encapsulated with the compositions of this invention. The modules are preferably water-tight.

The principle components of the preferred modules of this invention are a transparent glazing or incident layer, preferably glass, the encapsulant, the silicon wafers and associated wiring, and a protective backsheet or backing. Other components can be included.

In an alternative embodiment, the invention is directed to flexible modules containing thin film surface layers. They comprise a thin transparent polymeric film, such as fluoropolymer film, for example Tedlar® and Tefzel® films (DuPont), or a biaxially-oriented polyester (e.g., poly(ethylene terephthalate)) film (preferably comprising a fluoropolymer or a polyester film), crosslinked ethylene copolymer encapsulant, silicon wafers and associated wiring, and a flexible protective backsheet. Other components can be included.

In one preferred embodiment, a photovoltaic module is constructed from encapsulant provided in the form of sheets or films. One or more such sheets or films can be used, preferably two or three. According to a preferred version of this embodiment, the following parts starting from the top, or incident layer (that is, the layer first contacted by incident light) and continuing to the backing (the layer furthest removed from the incident layer): (1) incident layer/(2) encapsulant layer/(3) voltage-generating layer/(4) second encapsulant layer/(5) backing. The above structure consisting of incident layer, encapsulant, “string” of cells, encapsulant, is heated to allow the encapsulant to flow around the cells and bond to the incident layer, the cells and the backing layer, and if necessary further heated to effect crosslinking of the encapsulant. Preferably the resulting “laminate” is then sealed around the edges and ends, preferably using copper ribbons, framed using a rigid profile, (typically extruded aluminum). Electrical connections are added to complete the module.

The encapsulating (encapsulant) layer is designed to encapsulate and protect the fragile crystalline silicon cells. In a preferred embodiment, the encapsulant layer comprises two polymeric layers sandwiched around the voltage generating layer. The two encapsulant layers can be the same material or different and distinct materials. However, the optical properties of at least the first encapsulant layer must be such that light can be effectively transmitted to the voltage-generating layer. Thus, the first layer is preferably the composition of this invention. In addition, any other encapsulating layers are preferably the composition of this invention.

The function of the incident layer is to provide a transparent protective window that will allow sunlight into the cell module. The incident layer is typically a glass plate or a transparent organic polymer, such as a polycarbonate, polymethylmethacrylate, polyethylene terephthalate, or fluoropolymer (e.g., ethylene-tetrafluoroethylene (e.g. TEFZEL ETFE (DuPont) or Tedlar® (DuPont)). It can be any material which is transparent to sunlight and which provides suitable transparency and physical properties for the intended environment. Preferred for many applications is glass.

Many types of photovoltaic solar cells (i.e., semiconductors) can be encapsulated with the compositions of this invention. They include any article which can convert light into electrical energy, such as those called: (1) single-crystal silicon solar cells, (2) polycrystal silicon solar cells, (3) amorphous silicon based solar cells, (4) copper indium selenide solar cells, (5) compound semiconductor solar cells, and (6) dye-sensitized solar cells. In the case of crystalline silicon cells, the voltage-generating layer is typically a “string” of crystalline silicon cells. A “string” consists of a set of cells connected in series wherein the anode of one cell is connected electrically and mechanically to the cathode of the next cell by a conductor, generally copper ribbon attached to the cells by soldering. The cells generally have the cathode and the anode disposed on opposite faces, but some designs have the anode and the cathode both placed on the side opposite the sun (“back side contact cells”). Having both sets of electrodes on the same side simplifies the electrical connections.

A solar cell backing functions to protect the solar cell module from the deleterious effects of the environment. The requirements for a solar cell backing are: (1) good weatherability (that is, resistance to the effects of weather); (2) high dielectric strength; (3) low moisture vapor transmission rate (MVTR); and (4) mechanical strength. The backing layer must also have good adhesion to the second encapsulant layer, to prevent delamination.

If desired, one or both surfaces of the film and sheet may be treated to enhance the adhesion to other laminate layers. This treatment may take any form known within the art, including adhesives, primers, such as silanes, flame treatments, such as disclosed within U.S. Pat. No. 2,632,921, U.S. Pat. No. 2,648,097, U.S. Pat. No. 2,683,894, and U.S. Pat. No. 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. For example, U.S. Pat. No. 5,415,942 discloses a hydroxy-acrylic hydrosol primer coating that may serve as an adhesion-promoting primer for poly(ethylene terephthalate) films.

Any of the layers of the solar cell laminate, (such as, for example, the glass), may have a layer of adhesive or primers to enhance the bond strength between the laminate layers, if desired. The adhesive layer preferably takes the form of a coating. The adhesive/primer coating is less than about 1 mil thick. Preferably, the adhesive/primer coating is less than about 0.5 mil thick. More preferably, the adhesive/primer coating is less than about 0.1 mil thick. The adhesive may be any adhesive or primer known within the art. Preferably, the adhesive or primer is a silane which incorporates an amine function. Specific examples of such materials include, for example; gamma-aminopropyltriethoxysilane, N-beta-(aminoethyl)-gamma-aminopropyl-trimethoxysilane, and the like and mixtures thereof. Commercial examples of such materials include, for example A-1100® silane, (from the Silquest Company, formerly from the Union Carbide Company, believed to be gamma-aminopropyltrimethoxysilane) and Z6020® silane, (from the Dow Company).

The adhesives may be applied through melt processes or through solution, emulsion, dispersion, and the like, coating processes. One of ordinary skill in the art will be able to identify appropriate process parameters based on the composition and process used for the coating formation. The above process conditions and parameters for making coatings by any method in the art are easily determined by a skilled artisan for any given composition and desired application. For example, the adhesive or primer composition can be cast, sprayed, air knifed, brushed, rolled, poured or printed or the like onto the surface. Generally the adhesive or primer is diluted into a liquid medium prior to application to provide uniform coverage over the surface. The liquid media may function as a solvent for the adhesive or primer to form solutions or may function as a non-solvent for the adhesive or primer to form dispersions or emulsions. Adhesive coatings may also be applied by spraying the molten, atomized adhesive or primer composition onto the surface. Such processes are disclosed within the art for wax coatings in, for example, U.S. Pat. No. 5,078,313, U.S. Pat. No. 5,281,446, and U.S. Pat. No. 5,456,754.

Glass laminated products are used in transportation or vehicular applications (e.g. automobiles, airplanes, trains, boats, etc., as windows, windshields, sidelights, lights, etc.), architectural applications (buildings and other structures, including windows, stairs, ceilings, walls, skylights, shelves, display cabinets, partitions, etc.), etc., to enhance safety. Typically glass laminated products contain at least one sheet of glass or other transparent rigid material laminated to films or sheets that form other layers that provide strength, adhesiveness, or other properties to the laminate. The invention is directed to use of sheets or films of the composition comprising an ethylene copolymer blended with from about 150 to about 1,000 parts by weight per million parts by weight of the ethylene copolymer of a fatty acid amide as layers in such laminates.

The rigid sheet may be glass or rigid transparent plastic sheets, such as, for example, polycarbonate, acrylics, polyacrylate, cyclic polyolefins, such as ethylene norbornene polymers, metallocene-catalyzed polystyrene and the like and combinations thereof. Metal or ceramic plates may be substituted for the rigid polymeric sheet or glass. The term “glass” is meant to include not only window glass, plate glass, silicate glass, sheet glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex® glass and the like. Such specialty glasses are disclosed in, for example, U.S. Pat. No. 4,615,989, U.S. Pat. No. 5,173,212, U.S. Pat. No. 5,264,286, U.S. Pat. No. 6,150,028, U.S. Pat. No. 6,340,646, U.S. Pat. No. 6,461,736, and U.S. Pat. No. 6,468,934. The type of glass to be selected for a particular laminate depends on the intended use.

Thus, in one embodiment the invention is directed to a laminate comprising:
(a) a sheet of glass or other transparent rigid material, preferably glass;
(b) a layer of a composition comprising an ethylene copolymer blended with from about 150 to less than 500 parts by weight per million parts by weight of the ethylene copolymer of a fatty acid amide as layers in such laminates.
   The above embodiment can, of course, contain additional layers of glass or the composition, as well as other layers useful in such laminates.

The sheet of glass or other transparent rigid material can be laminated (i.e., adhered) to the lay of the composition directly or indirectly. In a preferred embodiment, they are adhered to each other. In another preferred embodiment, they are adhered to each other by a layer of a polyester film (preferably polyethylene terephthalate) that has been coated with a polyallylamine coating (preferably coated on both sides), such as described in US 2005-0129954 A1.

Glass laminates preferably contain the glass or rigid layers on one or both outer sides of the laminate. Some glass laminates comprise a hardcoat, such as a polysiloxane abrasion resistant coating, on one of the outside layers usually with glass on the outside layer. These hardcoats can be adhered to the compositions of the invention, other interlayers, or through special layers such as the polyester film that has been coated with a polyallylamine coating (preferably coated on both sides), such as described in US 2005-0129954 A1.

Other typical polymer interlayers that can be used are polymer layers comprising a polymer selected from the group consisting of polyvinyl acetals (preferably polyvinyl butyral), ionoplast resin; polyurethanes; polyvinyl chlorides; ethylene copolymers (other than those of this invention, e.g., ethylene vinyl acetate); and ethylene acid copolymers. (See, e.g., US 2005-0129954 A1.) These interlayers can contain additives such as adhesion additives, peroxide additives, UV or thermal stabilizer packages, etc.

The laminates of the present invention may incorporate additional polymeric films. Preferably, the polymeric film is transparent. Preferable polymeric film materials include: polyester (preferably poly(ethylene terephthalate)), polycarbonate, polypropylene, polyethylene, polypropylene, cyclic polyloefins, norbornene polymers, polystyrene, syndiotactic polystyrene, styrene-acrylate copolymers, acrylonitrile-styrene copolymers, poly(ethylene naphthalate), polyethersulfone, polysulfone, nylons, poly(urethanes), acrylics, cellulose acetates, cellulose triacetates, cellophane, vinyl chloride polymers, polyvinyl fluoride, polyvinylidene fluoride and the like. Most preferably, the polymeric film is biaxially oriented polyester, even more preferably biaxially oriented poly(ethylene terephthalate) film.

The thickness of the polymeric film is not critical and may be varied depending on the particular application. Generally, the thickness of the polymeric film will range from about 0.1 mils (0.003 mm), to about 10 mils (0.26 mm). For automobile windshields, the polymeric film thickness may be preferably within the range of about 1 mil (0.025 mm), to about 4 mils (0. 1 mm).

Typical configurations of glass laminates are as follows:

GLASS/COMP/GLASS

GLASS/COMP/HC

GLASS/COMP/ADD/HC

GLASS/COMP/INTL (NOT COMP)/GLASS

GLASS/COMP/INTL (NOT COMP)/HC

GLASS/INTL (NOT COMP)/COMP/HC

GLASS/COMP/INTL (NOT COMP)/ADD/HC

GLASS/INTL (NOT COMP)/COMP/ADD/HC

GLASS/COMP/ADD/INTL/HC

GLASS/INTL/ADD/COMP/ADD/HC

GLASS/COMP/ADD/INTL/ADD/HC

GLASS/INTL/ADD/COMP/ADD/HC

GLASS/COMP/ADD/INTL/ADD/INTL/GLASS

GLASS/COMP/ADD/INTL/ADD/INTL/HC

GLASS/COMP/ADD/INTL/ADD/ADD/INTL/GLASS

GLASS/COMP/ADD/INTL/ADD/INTL/HC

GLASS/COMP/ADD/INTL/ADD/ADD/INTL/HC

GLASS/INTL/ADD/INTL/ADD/COMP/HC

GLASS/INTL/ADD/INTL/ADD/COMP/ADD/HC

OTHER

Wherein:

COMP=layer of a composition comprising an ethylene copolymer blended with from about 150 to less than 500 parts by weight per million parts by weight of the ethylene copolymer of a fatty acid amide as layers in such laminates.

INTL=layers comprising a polymer selected from the group consisting of polyvinyl acetals (preferably polyvinyl butyral), ionoplast resin; polyurethanes; polyvinyl chlorides; ethylene copolymers (other than those of this invention, e.g., ethylene vinyl acetate); and ethylene acid copolymers, or a second layer of COMP. Preferably when this layer is not COMP it is a layer of polyvinyl butyral or ionoplast resin.

GLASS=Glass or a rigid material that is used in place of glass in this type of laminate, and is preferably glass.

ADD=polyester film (preferably polyethylene terephthalate) that has been coated with a polyallylamine coating (preferably coated on both sides), such as described in US 2005-0129954 A1 or similar layers.

HC=a hardcoat as described above.

OTHER=other variations on the above multilayer laminates wherein COMP and INTL are interchanged, such as GLASS/ADD/INTL/ADD/COMP/ADD/ADD/INTL/HC.

Process or lamination conditions are well known and will depend on the specific materials used, size, etc.

The following describes a specific example for the preparation a glass/COMP sheet/glass laminate of the present invention through an autoclave process. The laminate may be formed by conventional autoclave processes known within the art. In a typical process, a glass sheet, an interlayer composed of the COMP sheet and a second glass sheet are laminated together under heat and pressure and a vacuum (for example, in the range of about 27-28 inches (689-711 mm) Hg), to remove air. Preferably, the glass sheets have been washed and dried. A typical glass type is 90 mil thick annealed flat glass. In a typical procedure, the interlayer of the present invention is positioned between two glass plates to form a glass/interlayer/glass assembly, placing the assembly into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 130° C. to about 180° C., at a pressure of about 200 psi (15 bars), for from about 10 to about 50 minutes. Preferably the bag is autoclaved at a temperature of from about 120° C. to about 160° C. for 20 minutes to about 45 minutes. More preferably the bag is autoclaved at a temperature of from about 135° C. to about 160° C. for 20 minutes to about 40 minutes. Most preferably the bag is autoclaved at a temperature of from about 145° C. to about 155° C. for 25 minutes to about 35 minutes. A vacuum ring may be substituted for the vacuum bag. One type of vacuum bags is disclosed within U.S. Pat. No. 3,311,517.

Alternatively, other processes may be used to produce the laminates of the present invention. Any air trapped within the glass/interlayer/glass assembly may be removed through a nip roll process. For example, the glass/interlayer/glass assembly may be heated in an oven at between about 80 and about 120° C., preferably between about 90 and about 100° C., for about 30 minutes. Thereafter, the heated glass/interlayer/glass assembly is passed through a set of nip rolls so that the air in the void spaces between the glass and the interlayer may be squeezed out, and the edge of the assembly sealed. The assembly at this stage is referred to as a pre-press.

The pre-press assembly may then placed in an air autoclave where the temperature is raised to between about 120° C. and about 160° C., preferably between about 135° C. and about 160° C., and pressure to between about 100 psig to about 300 psig, preferably about 200 psig (14.3 bar). These conditions are maintained for about 15 minutes to about 1 hour, preferably about 20 minutes to about 50 minutes, after which, the air is cooled while no more air is added to the autoclave. After about 20 minutes of cooling, the excess air pressure is vented and the laminates are removed from the autoclave. This should not be considered limiting. Essentially any lamination process known within the art may be used with the interlayers of the present invention.

As described above, the laminates of the present invention may optionally include additional layers, such as other rigid sheets, other polymeric sheets, other polymeric films.

The laminates of the present invention may also be produced through non-autoclave processes. Such non-autoclave processes are disclosed, for example, within U.S. Pat. No. 3,234,062, U.S. Pat. No. 3,852,136, U.S. Pat. No. 4,341,576, U.S. Pat. No. 4,385,951, U.S. Pat. No. 4,398,979, U.S. Pat. No. 5,536,347, US 5,853,516, U.S. Pat. No. 6,342,116, U.S. Pat. No. 5,415,909, US 2004/0182493, EP 1 235 683 B1, WO 91/01880 and WO 03/057478 A1. Generally, the non-autoclave processes include heating the pre-press assembly and the application of vacuum, pressure or both. For example, the pre-press may be successively passed through heating ovens and nip rolls.

### EXAMPLES

Stick Temperature

In the examples quoted below the stick temperature is defined as the maximum temperature at which all the polymer pellets empty from the test apparatus in less than one minute following holdup under fixed conditions. The test procedures are described in U.S. Pat. No. 4,510,281.

The stick temperature of a given copolymer will to some extent depend on the size and shape of the pellets. Smaller, nonspherical pellets block more readily than larger, spherical pellets. Therefore, it is important to run a control experiment for each stick temperature determination. All the pellets used in the examples below weighed 1.8-3.2 g per 100 pellets and were approximately spherical. In addition, the stick temperature is affected by other factors, such, for example, as the particular pelletizing technique and equipment and subsequent handling. Thus, the stick temperature of commercial pellets of a given polymer will usually be higher than that of laboratory-made pellets of the same polymer.

Haze

Haze is measured using the following procedure:
(a) Prepare a 0.125″ (3.175 mm) thick sample of the polymer to be tested by the following process. (This sample can be the polymer prior to use in a module or can be obtained by obtaining a polymer from a module.)
(b) Place the polymer (which can be any form, but is typically in a pellet or film form) into a mold of the desired thickness which is contained in a heated, hydraulic press maintained at a temperature of 190° C. Sheets of a high-melting polymer (i.e., that melts at a temperature higher than 190° C., such as Teflon® film) are placed on both sides of the mold in order to encapsulate the pellets in the mold.
(c) Apply “minimum” pressure to the hydraulic press. Here, “minimum” means contacting the surface of the polymer/pellets to be melted and maintain for 5 minutes.
(d) Increase the pressure on the hydraulic press to 10,000 psi and maintain for 3 minutes.
(e) Increase the pressure on the hydraulic press to 20,000 psi and maintain for 1 minute.
(f) Turn off the heating supply to the press and start to circulate cooling water through the press.
(g) Cool the polymer until it is at a temperature below 35° C.
(h) The sample should then be allowed to age under controlled conditions of temperature and relative humidity per the requirements on ASTM D-1003. The surface of the sample should be reasonably smooth and free of debris or fingerprints in the path which the light beam used to measure haze will pass.
(i) Haze can then be measured per the method of ASTM D-1003.

Pellets

All the pellets used in the examples were made in the laboratory by repelletizing additive-free commercial polymer pellets.

Table 1 contains a different set of results for a 32% VA/43 MI copolymer. In this case, results were obtained at levels of N,N ethylene-bis-oleamide (EBO) at levels of 500 ppm EBO or lower. A small increase in stick temperature is seen as the concentration of amide is increased, indicating that improvement in handling is seen almost immediately upon adding amide to the polymer blend. Furthermore, a measure of qualitative flowability was constructed as an alternative to the stick temperature measurement, as the differences in stick temperature between the control and 500 ppm EBO states are quite small. Qualitative flowability was determined by slowly pouring pellets from one container to another while observing the tendency of the pellets to flow during the transfer. At low flowability numbers, pellets often appear to “crawl” over one another, tend to flow non-uniformly, and even at times appear to adhere to one another as they are poured. At high flowability numbers, little resistance to flow is seen and pellets steadily flow from one container to another in an uninterrupted and uniform fashion. Qualitative flowability also shows a steady increase as a function of amide content. In Table 1, a flowability of 0 means that pellets stick together, and 5 means that they flow freely. A marked increase in flowability is seen at the 200 ppm level.

In addition, Table 1 shows haze data obtained using the above haze measurement techniques on plaques that were 3.175 mm thick (0.125″ thick) for levels of EBO from 0 to 3000 ppm. The data show the unexpected lack of effect of EBO on haze up to 500 ppm.

TABLE 1

| EBO Level | Stick Temp C. | Haze | Flowability |
|---|---|---|---|
| 0 | 26 | 17.2 | 1 |
| 100 | 28 | 19.2 | 1 |
| 200 | 29 | 20.5 | 3 |
| 300 | 30 | 18.8 | 3 |
| 400 | 30 | 21.0 | 3 |
| 500 | 32 | 18.7 | 4 |
| 1,000 | — | 28.3 | 4 |
| 3,000 | — | 35.0 | 5 |
| 4,000 | 39 | — | 5 |

Pellets made by this invention can be used in applications that are susceptible to haze while imparting sufficient block improvement for improved handling.

The foregoing disclosure of embodiments of the present invention has been presented for purposes of illustration and description. It is not intended to be exhaustive or to limit the invention to the precise forms disclosed. Many variations and modifications of the embodiments described herein will be evident to one of ordinary skill in the art in light of the above disclosure.

What is claimed is:

1. An electronic device comprising an electronic component encapsulated by a composition comprising crosslinked ethylene copolymer blended with from about 150 to about 1,000 parts by weight per million parts by weight (ppm) of the ethylene copolymer of fatty acid amide.

2. The electronic device of claim 1 which is a photovoltaic solar cell module wherein the electronic component comprises photovoltaic cells and the composition is a transparent composition.

3. The electronic device of claim 2 wherein the composition contains less than 500 ppm of the fatty acid amide.

4. The electronic device of claim 3 wherein the composition contains at least about 200 ppm of the fatty acid amide.

5. The electronic device of claim 3 wherein the composition contains 490 ppm or less of the fatty acid amide.

6. The electronic device of claim 3 wherein the composition contains about 450 ppm or less of the fatty acid amide.

7. The electronic device of claim 3 wherein the fatty acid amide is selected from the group consisting of olefinic bisoleamides, erucamide, stearamide, behenamide, oleamide, and mixtures thereof.

8. The electronic device of claim 3 wherein the fatty acid amide is selected from the group consisting of olefinic bisoleamides and mixtures thereof.

9. The electronic device of claim 3 wherein the fatty acid amide is selected from the group consisting of N,N′-ethylenebisoleamide, N,N′-ethylenebiserucamide, N,N′-dioleyladipamide, N,N′-dierucyladipamide, and mixtures thereof.

10. The electronic device of claim 3 wherein the photovoltaic solar cell module comprises a glass glazing, the silicon wafers and associated wiring encapsulated by the composition, and a protective backsheet.

11. The electronic device of claim 3 wherein the photovoltaic solar cell module comprises a thin transparent polymeric film, the photovoltaic cells and associated wiring encapsulated by the composition, as a flexible protective backsheet.

12. The electronic device of claim 11 wherein the thin transparent polymeric film is selected from the group consisting of fluoropolymer and poly(ethylene terephthalate) films.

13. The electronic device of claim 3 wherein the composition has a haze value of up to about 20.

14. The electronic device of claim 3 wherein the composition has a stick temperature of at least about 25° C.

15. The electronic device of claim 2 wherein the composition has a haze value of less than 10% more than the same composition prepared without the fatty acid amide.

16. The electronic device of claim 2 wherein the ethylene copolymer is an ethylene vinyl acetate copolymer.

17. The electronic device of claim 2 wherein the ethylene copolymer is selected from the group consisting of ethylene-alkyl (meth)acrylate copolymers.

18. The electronic device of claim 2 wherein prepared from a laminate comprising a transparent cover layer, a backsheet on the side opposite the transparent layer, first and second sheets disposed between the transparent cover layer and the backsheet and each comprising the composition, and an array of electrically interconnected photovoltaic cells disposed between the first and second support sheets.

19. A composition comprising ethylene copolymer blended with from about 150 to less than 500 parts by weight per million parts by weight (ppm) of the ethylene copolymer of fatty acid amide.

20. The composition of claim 19 wherein the composition contains 490 or less of the fatty acid amide, the composition has a haze value of up to about 20, and the fatty acid amide is selected from the group consisting of N,N′-ethylenebisoleamide, N,N′-ethylenebiserucamide, N,N′-dioleyladipamide, and N,N′-dierucyladipamide, and mixtures thereof.

21. A transparent laminate comprising at least one layer of transparent glass or other rigid transparent material and at least one layer of a transparent composition comprising an ethylene copolymer blended with from about 150 to 1,000 parts by weight per million parts by weight of the ethylene copolymer of a fatty acid amide.

22. The transparent laminate of claim 21 wherein the composition contains less than 500 ppm of the fatty acid amide.
